(19) United States
(12) Patent Application Publication
(10) Pub. No.: US 2011/0208532 A1
(43) Pub. Date: Aug. 25, 2011

(54) MANAGING HEALTH DATA FROM WITHIN AND OUTSIDE A UPnP NETWORK

(75) Inventors: Mahfuzur Rahman, Santa Clara, CA (US); Alan Messer, Los Gatos, CA (US)

(73) Assignee: SAMSUNG ELECTRONICS CO., LTD., Suwon City (KR)

(21) Appl. No.: 12/824,890

(22) Filed: Jun. 28, 2010

Related U.S. Application Data
(60) Provisional application No. 61/307,378, filed on Feb. 23, 2010.

(51) Int. Cl. G06Q 50/00; G06Q 10/00; G06F 21/00

(52) U.S. Cl. 705/2; 726/4

(57) ABSTRACT

Health data measurement devices may be used in a UPnP home network to obtain health data and have the data stored in personal health records in an application hosting device in the network. Various types of devices may be used to access the data and to render the data on displays in the home network, such as televisions, using UPnP protocols. A health sensor device has an IP-LAN UPnP health service module and a possible a control point. An application hosting device, which stores and manages the health data, has a host UPnP health service module and may also have a control point. A remote device, such as a cell phone, may be used to remotely access health data on the application hosting device. A remote device description is dynamically generated by the hosting device based on a configuration set in a remote access service on the hosting device. The remote device description is generated dynamically (“on the fly”) as the remote device attempts to access data in the UPnP network.

### CROSS-REFERENCE TO RELATED APPLICATIONS

This application claims the benefit of U.S. Provisional Patent Application No. 61/307,378, titled “System and Method to Share eHealth Information From Within and Outside of UPnP Network”, filed Feb. 23, 2010 (Attorney Ref. No. SISAP107P), which is hereby incorporated by reference in its entirety and for all purposes.

### BACKGROUND OF THE INVENTION

1. Field of the Invention

The present invention relates generally to computer networks and devices for managing health data from home monitoring devices. More specifically, the invention relates to hardware devices for managing, collecting, and storing health-related data over a network, in particular, a home network using home measurement devices.

2. Description of the Related Art

Electronic health management in the home environment, also known as eHealth, is a rapidly growing field. Healthcare consumers are becoming more sophisticated by trying to manage their conditions, in many cases, a chronic disease or condition, from the home or work place, by taking self measurements. That is, they are using “home” health monitor/device, such as glucose meters, scales, blood pressure cuffs, breathing devices, and several other instruments, to take measurements of their conditions while at home or at work, and storing these measurements, often referred to as biometric data, in computers or network servers, from where the data can be accesses by healthcare providers or by the patients themselves at a later time for evaluation. This growth in eHealth is, naturally, of interest to healthcare providers to device manufactures (“device” referring to a home health monitor), who are attempting to make devices that are easy to use at home and can seamlessly connect with a home network and without requiring that the user (many of whom may be elderly or disabled) be technologically savvy, especially with respect to networking. It is also a growing trend for families to collect and manage their own health care data in a home network to avoid higher health care costs.

A standards organization known as Continua Health Alliance, formed a few years ago, provides interoperable solutions for connected home monitoring devices. These devices are currently focused on low power local area network (LAN)/personal area network (PAN) devices within the home network that are not IP-enabled. These interoperable devices operate with health sensors, also referred to as home biometric devices, such as blood pressure monitors or glucose meters. These interoperable devices are referred to as personal area network (PAN) devices (which typically use Bluetooth) and Low-Power LAN devices (LP-LAN) (which typically use Zigbee). Continua Health Alliance defines devices that measure health care data and interact with other eHealth devices. However, its current focus is in non-IP type devices that use Bluetooth, Zigbee, or other RF communication means, as the communication medium for receiving data from the health sensor devices. They are non-IP enabled. These devices have physical Continua interfaces with software elements for data transport. However, they require that health data be transmitted using a non-IP transport means.

Currently there is no interoperable solution for IP-based home health monitor devices to operate in and out of a UPnP home network. It would be desirable to have IP-based LAN health measurement devices within the home network and operating remotely (e.g., in a wide area network, WAN) that can communicate with one or more application hosting devices (AHDs) in the home network.

### SUMMARY OF THE INVENTION

One aspect of the invention is a method of man health measurement data on a health management host device in a Universal Plug and Play (“UPnP”) network. A health data query is transmitted utilizing a UPnP request to a health sensor device, where the query may use a UPnP request protocol. Health measurement data is received from the health sensor device via a UPnP interaction and the health data is stored as a personal health record in the host device. Access to the health data may be managed using a UPnP health management service, where the host device and the health sensor device are discoverable in the UPnP network. In one embodiment, one or more device descriptions are dynamically generated for determining access to health data in the host device.

In another aspect of the invention, a system for managing health sensor measurement data in a UPnP network is described. A health-management application hosting device stores personal health sensor data and has a hosting UPnP service module for managing the personal health sensor data, an access control component for controlling access to the health sensor data, and a health data synchronization module. A health sensor device executes biometric readings and stores the readings. The sensor device has an IP-enabled interface, a IP device UPnP service module, and a health-sensor device control point module. The biometric readings may be stored as personal health sensor data on the health-management application hosting device and are transmitted using a UPnP interaction. The health-sensor device control point module communicates with the hosting UPnP service module on the health-monitoring hosting device. In one embodiment, the health-management application hosting device may have a remote health sensor data access module and a security configuration module. The security module may have a remote access control module, a filtering service module, and a dynamic device description generation module.

Another aspect of the invention is a method of remotely accessing health measurement data in a UPnP network. A request from a remote device to access health data on a health data server in a UPnP network is received. The security access of the remote device is verified to ensure that the device can securely access data on the server. Device descriptions for the remote device are generated using a device description generation module. Health data access authorization of the remote device is determined by examining health data access information and at least one of the dynamically generated remote device descriptions. In one embodiment, a device description is generated based on a configuration set in a remote access service.

### BRIEF DESCRIPTION OF THE DRAWINGS

References are made to the accompanying drawings, which form a part of the description and in which are shown, by way of illustration, particular embodiments:

FIGS. 1A and 1B are network diagrams showing components relevant to embodiments of the present invention;

FIG. 2 is an overview network diagram showing a greater number of components in an example home network in accordance with one embodiment of the present invention;

FIG. 3 is block diagram of an IP-enabled LAN device in accordance with one embodiment of the present invention;

FIG. 4 is a diagram showing a personal health record in accordance with one embodiment of the present invention;

FIG. 5 is a block diagram of an application hosting device (AHD) in accordance with one embodiment of the present invention;

FIG. 6 is a flow diagram of a process of connecting an IP-LAN device to a UPnP network and eventually storing health measurement data on an AHD in accordance with one embodiment;

FIG. 7 is a block diagram showing one possible way to render personal health record data on a television using a cell phone or other mobile device in accordance with one embodiment;

FIG. 8 is a network diagram illustrating UPnP interactions between the AHD and the device for the management of health data in accordance with one embodiment;

FIG. 9 is a block diagram showing supporting modules of a remote access configuration module in accordance with one embodiment;

FIG. 10 is a flow diagram of a process of accessing health care data from a remote device in accordance with one embodiment; and

FIGS. 11A and 11B show one physical implementation of a computing system suitable for implementing various devices of the present invention.

### DETAILED DESCRIPTION OF THE INVENTION

Methods and devices for collecting, storing, and managing health measurement data from health sensors in a home network using Universal Plug and Play (UPnP) protocols are described in the various figures. Systems and methods for sharing health record measurement data among health sensors within a home network and accessing health devices in the home network from a wide area network are also described. Various embodiments of the present invention enable IP-based LAN health data measurement devices to operate within a home network operating under the UPnP protocols. Such devices can communicate with application hosting devices (AHDs) and with devices, such as smart phones, external to the home network, that is, in a WAN. Various embodiments also provide systems and methods for a remote device to communicate with IP-based LAN devices in the home network. This makes use of Universal Plug and Play (UPnP) technologies and of extensions to UPnP remote access technologies.

Before describing embodiments of the invention, it is useful to provide an overview of UPnP. UPnP is a set of networking protocols promulgated by the UPnP Forum. The goals of UPnP are to allow devices to connect seamlessly in a network and to simplify the implementation of networks in the home (data sharing, communications, and entertainment). In corporate environments it is used for simplified installation of computer components. It achieves this by defining and publishing UPnP device control protocols (DCP) built upon open, Internet-based communication standards. UPnP devices are “plug-n-play” in that when connected to a network they automatically announce or advertise their network address and supported device and service types, enabling clients that recognize those types to immediately begin using the device.

UPnP uses control points (CP) to control services, also referred to as DCPs, provided by devices. Control points provide a device control protocol to access, control, and manage services. In the described embodiment, each device in a UPnP network may implement a health data-related service or DCP and each may have a CP to communicate with other devices. In one embodiment of the present invention, a system and method are provided that enable health measurement devices to share information in a UPnP network. The innovation provides a method where devices outside the home network can communicate with devices in the home network using UPnP remote access and its extension to provide remote management of health care data. These embodiments can form the basis for a new working committee in UPnP for converged health data management solutions. In one embodiment, new features can be introduced to new devices including mobile and CE devices, health and fitness devices, and the like.

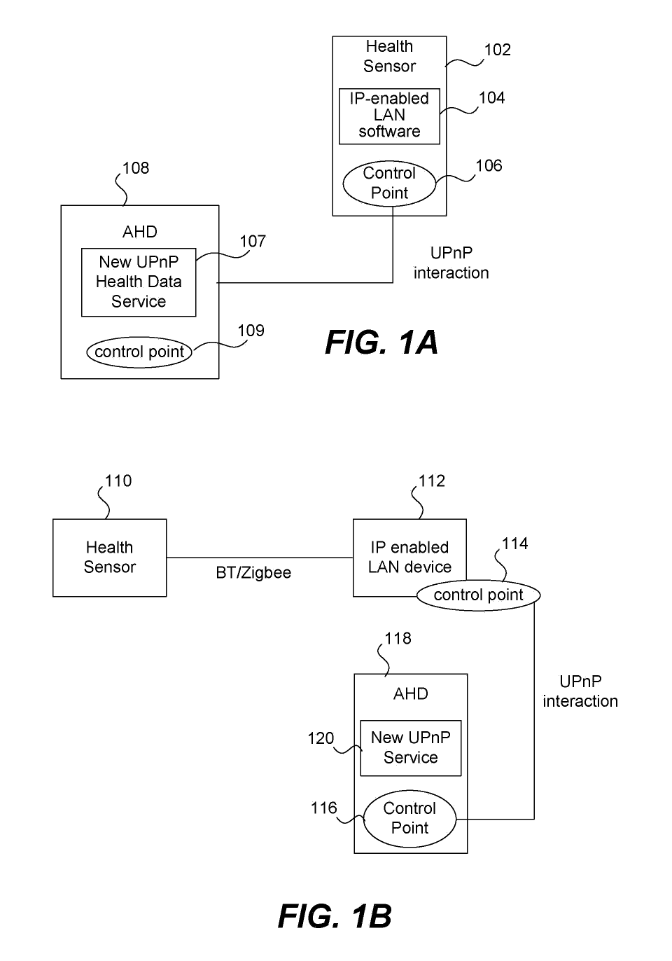

FIG. 1A is a network diagram showing components relevant to one embodiment of the present invention. A health sensor device 102 has software operating on it referred to as IP-enabled LAN software 104. Device 102 may be a blood glucose meter, blood pressure cuff, scale, or other biometric device and, as such, has numerous other components and modules, which are not directly relevant to the present invention and, thus are not shown. Software 104 may also have a control point module 106. A control point is a software module (in an existing device) or a dedicated physical device running only the control point (CP) software (it can reside anywhere in any device) and is used to control services (DCPs) for healthcare. Control points are specific to a particular service. They make requests to AHDs to perform certain services, such as accessing, deleting, uploading, updating, or browsing data. The control point is in communication with an application hosting device (AHD) 108 which also may have a control point software module. In one embodiment, AHD 108 also has a new UPnP service module. In other embodiments, AHD 108 may not have its own control point 109. In one embodiment AHD 108 is UPnP enabled and allows discovery of devices and provides, manages, and consumes content from devices in the network. Typically, a home network will have one AHD, but there may be multiple AHDs where one may be an AHD aggregator. In most cases, a UPnP device, such as the health sensor 102 or AHD 108, will have a control point. In one embodiment, there are two types of services: one for AHD (UPnP services and the other IP LAN device (UPnP LAN service).

FIG. 1B is a block diagram of a non-IP enabled health sensor (a LAN/PAN non-IP device) in a UPnP network. A health sensor 110 is a conventional sensor (currently available), that is, does not have an IP-enabled LAN software component or a control point, takes biometric readings (which may range from weight readings to glucose levels). For example, it may be a Continua type device that is light weight, but not IP enabled and does not operate in a UPnP network. The health sensor 110 communicates using Bluetooth or Zigbee with an IP-enabled LAN device 112. The types of RF interactions may depend on what type of health sensor device is being used.

The IP-enabled LAN device 112, a device of the present invention, may also be a health sensor device or may simply be an intermediate device. If it is an intermediate device, it is, in effect, also functioning as an AHD. The IP-enabled device has control point software 114 that is in communication with a control point 116 on an AHD 118 in the network, similar to the interaction shown in FIG. 1A. It also has UPnP IP LAN service 120, described in greater detail below. FIGS. 1A and 1B simply show the basic connections in a UPnP network. It is, of course, possible to have multiple health sensor devices, each having IP-enabled LAN software and a control point and communicating with an AHD. It may also be possible to have the devices communicate with each other (since, as noted, each may function as an AHD if it is not a health sensor and has a control point). The connection between the IP-enabled LAN device 112 and AHD 118 is a UPnP connection (whereas the connection between the health sensor and the device is not, given that the sensor is only capable of, in most cases, radio frequency communication, such as Bluetooth or Zigbee.

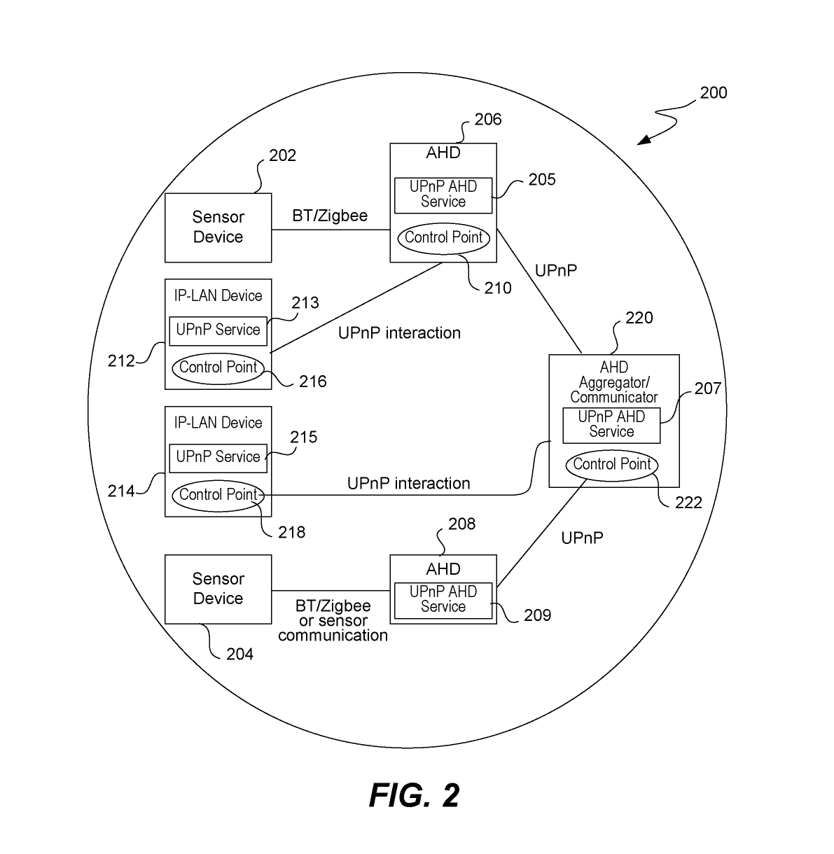

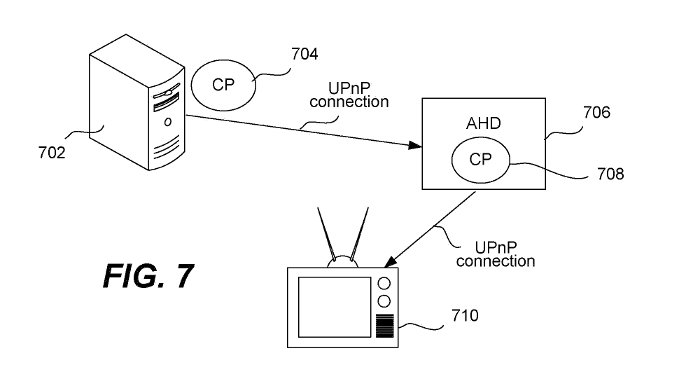

FIG. 2 is an overview network diagram showing a more detailed home network with a greater number of components in accordance with one embodiment. A network 200 has two health sensor devices 202 and 204 that are non-IP PAN/LAN devices (e.g., conventional or Continua type health sensor devices). As is known in the art, there are devices can communicate with AHDs 206 and 208, respectively. AHD 206 has a control point module 210 and UPnP AHD healthcare service 205. AHD 208 has a UPnP AHD healthcare service 209. Various embodiments of the present invention describe only UPnP interactions. The other health sensor devices are UPnP measurement devices 212 and 214 that are IP-LAN devices, each having a CP (module 216 in device 212 and module 218 in device 214). Each also has a UPnP service, shown by modules 213 and 215. IP-LAN device 212 communicates with AHD 206 via control points 216 and 210. This communication is over a UPnP connection, which may be wireless or wired. IP-LAN device 214 communicates with another AHD 220 over a UPnP connection using control points 218 and 222. AHD 220 is an AHD aggregator and communicator software module which may be an optional feature of the UPnP AHD service. It has a UPnP AHD healthcare service 207 as shown in FIG. 2. In another embodiment, the AHD aggregator may be a separate service (i.e., not a part of the UPnP AHD service). AHD 220 may also have a remote access enabler module for implementing access to the UPnP network from a remote (wide-area network “WAN”) device (not shown), described below. The IP LAN device or a control point can invoke action with an AHD device with UPnP AHD service and retrieve data or subscribe for changes from an AHD. Other types of communication of health data, such as using a push mechanism or a eventing mechanism, for rendering data on a consumer electronic device, such as a TV, are described in FIG. 7 below.

In one embodiment, a single AHD may have the remote access enabler for communication with external (WAN) devices. FIG. 2 shows a network having various types of connections and components with different capabilities. For example, some of the health measurement devices are IP-LAN enabled and have control points while others do not. The modes of communication include both RF, such as BT/Zigbee and UPnP. The AHDs may have a control point or remote access enabler depending on their functions or role in network 200.

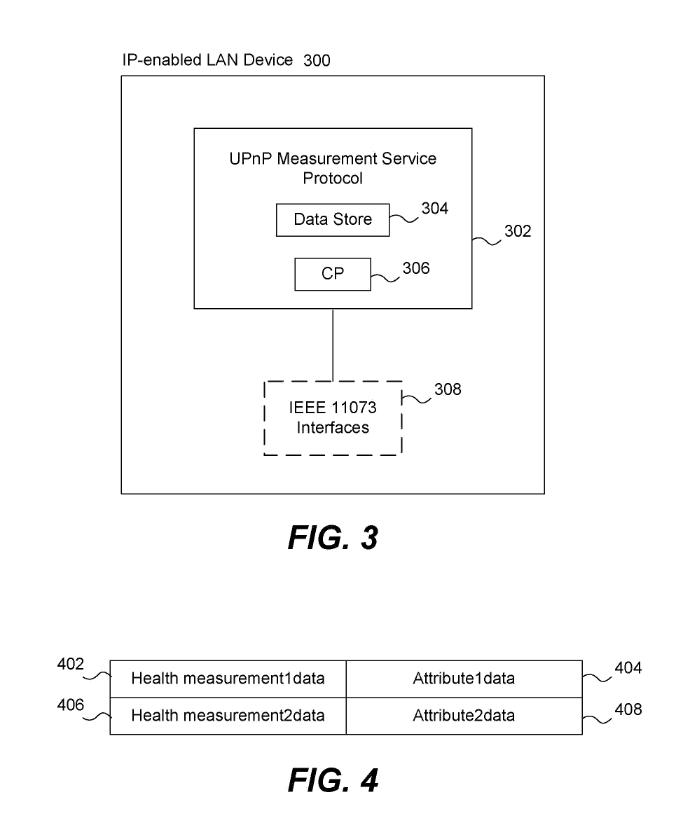

FIG. 3 is block diagram of an IP-enabled LAN device in accordance with one embodiment. As noted above, such a device is a health measurement device, also known as a biometric device. FIG. 3 only shows the components of IP device that are relevant to the present invention. The device may also function as an intermediate device, connecting a health measurement device with an AHD (in this scenario, the device essentially functions as an AHD). A device 300 has a UPnP measurement service protocol component 302 which is a new protocol in the UPnP standard for health measurement devices. Component 302 has a data store or memory component 304 for storing biometric readings or measurement data, such as weight, glucose levels, heart rate, blood pressure readings, and so on, depending on the type of measurement device. Also in component 302 is a control point module 304 needed for communicating or activating services in other devices in a UPnP network. Component 302 is also connected to IEEE 11073 interfaces 308.

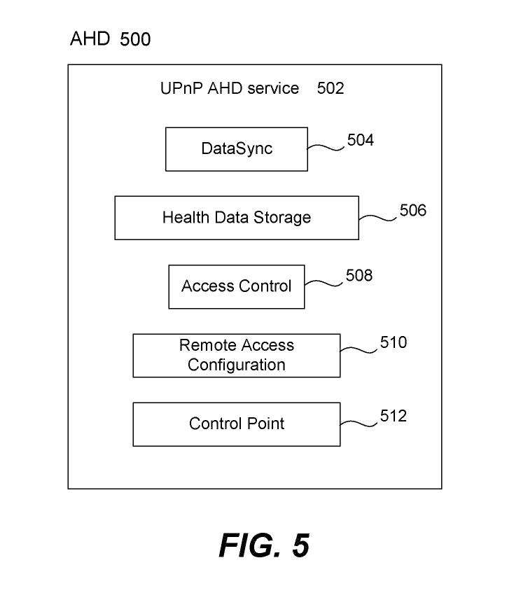

In one embodiment, health measurement data is stored as a personal health record, made up of a series (or one) health measurement data record. Each health measurement data record has associated attribute or property data which describes or characterizes the actual measurement reading (data) which may simply be a number, such as 180 or 140/92, or 0.5, and so on. This is shown in FIG. 4. Health measurement 1 data 402 has associated attribute 1 data 404. This may be followed by health measurement 2 data 406 and attribute 2 data 408. These data collectively comprise a personal health record which may be stored, temporarily in data store 304 and for long-term on the AHD, as described in FIG. 5. For example, health data from a scale may be “175” and one attribute data item may be units, such as “lbs” or “kgs.”

FIG. 5 is a block diagram of an application hosting device in accordance with one embodiment. An AHD may be implemented as a server computer in a home network. In many cases it (or an AHD aggregator) may be the focal point in a home network, similar to how a media server is commonly at the center of a home entertainment network. AHD 500 has a UPnP AHD service 502 which, in turn, has several new components relevant to management, storage, and communication of health management data in a UPnP network. The components include a data synchronization module 504, a health data storage component 506, an access control module 508, a remote access configuration module 510, and a control point 512. The AHD receives health measurement data from IP-LAN devices and other measurement devices in the network. These data, in the form of personal health records, are stored in data storage component 506. The AHD has services (as does the IP-enabled LAN devices) to manage the actual health measurements and their associated properties. For example, attributes may define or describe the actual measurement reading. For example, a reading may have an attribute such as blood sugar level, “lbs” and the like.

AHD 500 functions as a central storage or part of a central storage (if there is more than one) for all the personal health records for users in the network, such as, all the members of a family. The health data may be received directly from the sensors/biometric devices or from IP-LAN devices that function as intermediate devices (but are not sensors themselves). The health data synchronization service module 504 formulates or defines the overall personal health record. This structure is formulated by synchronization service 504. As would be expected, each user or member of the network has a different personal health record. The structure of the health record is, in one embodiment, a union of all the individual readings (measurement data and properties) from all the health sensors used by the individual. Control point 512 and the control points on the IP-enabled LAN devices are needed to control or manage the personal health records stored on the AHDs. They are used to manage and manipulate the data structure of the personal health record.

Access control 508 and remote access configuration 510 are needed for controlling and configuring which users in the network may have access to the personal health data and which users can control and further manipulate the data. As expected, access to the personal health records must be tightly controlled. Only certain users in a network should be able to configure, modify, or manage the health data stored on an AHD, due to the highly sensitive nature of the data. For example, only a parent in a home network should be able to manage personal health records for children in the house. One sibling or a child in the home network should not be allowed to see or manipulate health data for another sibling or even his or her own health data, for example, to maintain the integrity of the data.

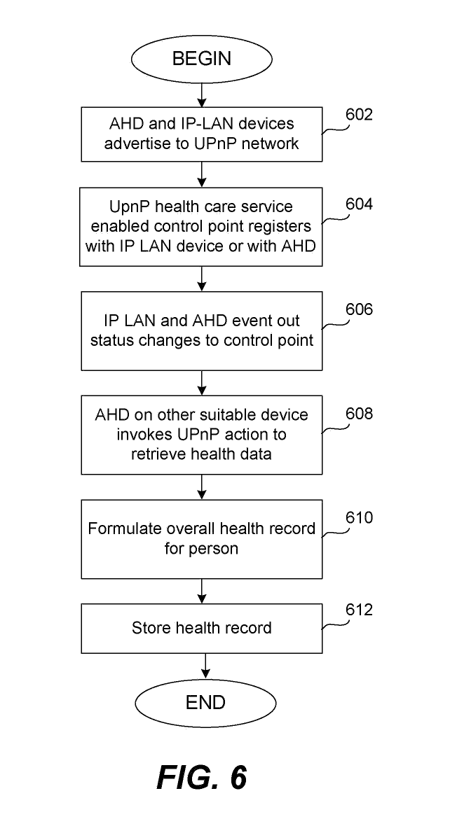

FIG. 6 is a flow diagram of a process of connecting an IP-LAN device to a UPnP network and storing health measurement data on an AHD in accordance with one embodiment. At step 602 an IP-LAN device, which is also a measurement device, connects to an UPnP network by advertising or announcing itself to the network. IP-LAN devices are able to do this, in contrast to the non-IP-enabled devices (e.g., lightweight Continua measurement devices). The AHD with UPnP healthcare service also advertises to the network in a similar manner using techniques known in the UPnP standard. Each type of device can advertise itself to the network at any time. At step 604 the control point-enabled with the UPnP healthcare service registers with the IP LAN device or with AHD have UPnP healthcare service for a status change. At step 606 the IP-LAN device or the AHD “events out” a status change to the control point enabled with a UPnP healthcare service when the control point has registered for such changes. For example, a TV with UPnP healthcare-enabled control point may register with an AHD to receive status updates, as further described in FIG. 7. At step 608 the AHD or other suitable device, such as a TV from the example above, invokes a UPnP action to retrieve health measurement data from the IP-LAN device or from the AHD. Thus, a control point-enabled with healthcare service can gather data from either of these types of devices. At step 610 the health data synchronization module formulates the overall personal health record for an individual user in the network. Finally, at step 612 the health measurement data is stored in a personal health record in the AHD.

FIG. 7 is a block diagram showing one possible way to render personal health record data on a television using a cell phone or other mobile device in accordance with one embodiment. Shown is a mobile device 702, such as a smart phone, a tablet computer, a remote control, or other mobile IP-enabled device. On it is control point software 704 that enables activating services in a UPnP network. In other embodiments, device 702 does have to be mobile but can be a stationary (such as a desktop computer) or a nomadic device (such as a laptop). Mobile device 702 is in communication with an AHD 706 over a UPnP network. AHD 706, which may be implemented as a server computer in the network or as an IP-enabled LAN device, has a control point 708. AHD 706 or, more specifically, control point 708, is in communication with a digital TV 710 or HDTV which can render the personal health data for viewing by the user. The user can use mobile device 702, such as the user's cell phone, to cause this rendering and control it using the interface on device 702. The rendering may occur on any suitable consumer electronic device, a TV being the most common example. The communication between AHD 706 and TV 710 is also a UPnP interaction. In this manner, the user can view personal health data on a TV in the home network and use a cell phone to control the display.

Control point 708 may be used to invoke an action to retrieve data and have the data rendered using two different mechanisms. The control point may request the UPnP AHD service to push the health data to TV 710 or other consumer electronic device, or any suitable rendering device. This may be done using a UPnP rendering service. In another embodiment, control point 708 may be in AHD 706 or in an IP LAN device. If TV 710 or other rendering device has a control point (not shown in FIG. 7), the control point may subscribe to event alerts and be notified when an alert or change in data occurs. This may be done by using an event messaging mechanism in the UPnP service which sends data, alerts, or information to TV 710. Thus, there are at least two ways to render the health data on a TV or consumer rendering device: using a push mechanism or using an eventing (subscribe and notification) mechanism, where TV 710 (having a CP) can subscribe to events (i.e., any changes to the data, alerts, or anything critical).

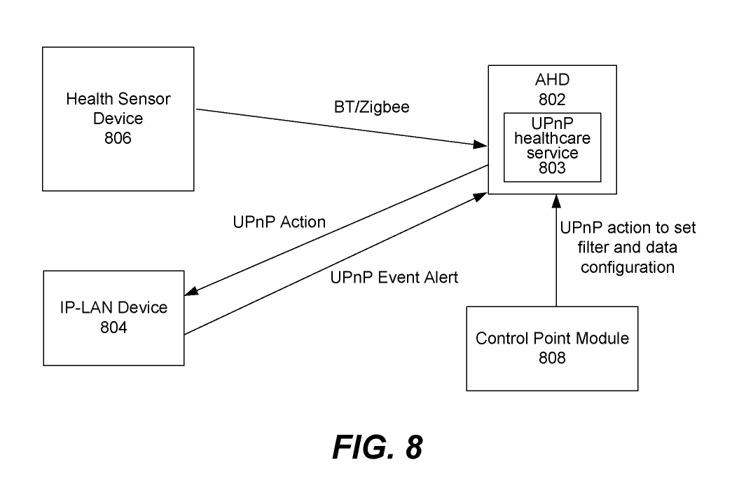

FIG. 8 is a network diagram illustrating UPnP interactions between the AHD and the IP-LAN enabled device for the management of health data in accordance with one embodiment. An AHD 802, having a UPnP healthcare service 803, is in communication with an IP-LAN device 804. It sends device 804 a UPnP action, such as invoking a “subscribe” action on the device so that the device will send UPnP “event” alerts to AHD 802. The AHD 802 may then invoke an action to update or retrieve health data from device 804 when a certain event occurs or, for example, when a threshold data value is reached on device 804 (e.g., when a blood pressure reading or glucose reading is above a certain value). As described above, the UPnP interaction between IP LAN device 804 and AHD 802 is action/event based. These communications or interactions are standard interactions in the UPnP protocols, but have not been used for communicating health related data from health sensor devices, such as device 804.

A conventional health sensor device (PAN/LAN device) 806 (that is not an IP-LAN device) and is known in the art, communicates with AHD 802, which has a RF interface for non-IP or non-UPnP interactions. It is shown to clarify how different types of devices can co-exist is the same network or environment. FIG. 8 shows that AHD 802 may be capable of interacting in at least two modes with health sensor devices: UPnP, such as WiFi or other IP-enabled means, and non-UPnP, such as RF. It can store data from these different types of health sensor devices. Similarly, IP-LAN device 804 may also have the same two interfaces. A control point 808 can be used to control, via UPnP, operations on AHD 802. For example, CP 808 can be used to set filter and data configuration on AHD 802, as described in greater detail below. CP 808 may be implemented in a dedicated physical device or may be a software module in AHD 802.

In various embodiments, a remote WAN device, can use UPnP to manage health records in a home network remotely, for example, from an office, school, or car. The remote device may be a cell phone, laptop computer, or other IP-enabled device. The remote device connects with an AHD or other UPnP device using a UPnP remote access connection. The UPnP AHD service that provides remote management of health records may have several supporting modules that provide dynamic generation of device descriptions and filtering of services based on access control. As described in greater detail below, a remote device description is hosted at the URL where the AHD resides. The AHD generates the device description based on the access level of the remote device. The supporting modules described below are specific to the AHD and does not need to be part of a remote access server, which provides secure remote access connection to the remote device. UPnP standards provide mechanisms to connect a remote UPnP device to the devices in a home UPnP network. One embodiment makes use of a UPnP remote access mechanism to enable remote devices to retrieve health data from devices in the home network. However, due to privacy and sensitivity of health data additional protection is required and which is provided in the UPnP AHD service. The UPnP AHD service generates two different types of device description, one for the home network and one for the remote device. The device description for the home network is not blocked at the remote access server, which is a server that follows the UPnP access standard to be propagated to the remote device by configuring the RAS. The access control set by the relevant control point determines the type of device description that will be generated by the AHD or other UPnP device for the remote device.

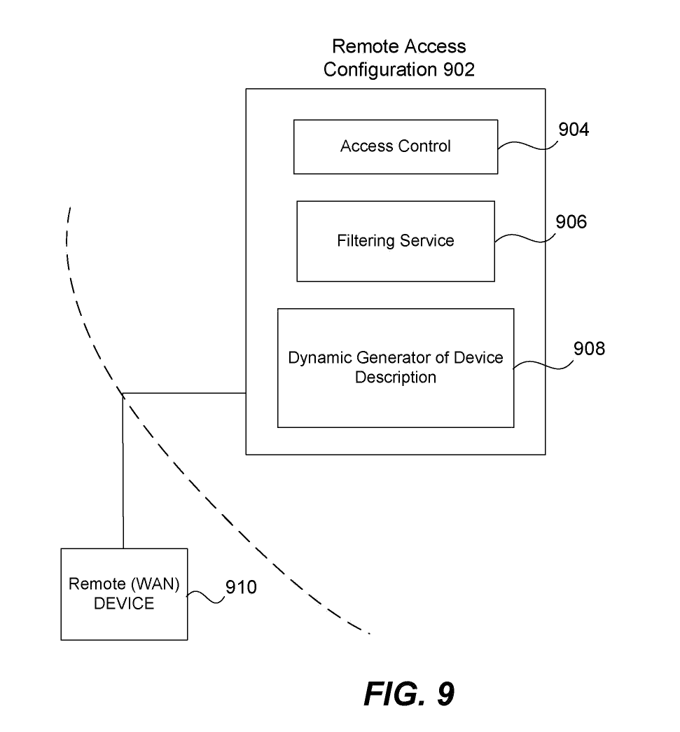

FIG. 9 is a block diagram showing supporting modules of a remote access configuration component in accordance with one embodiment. As noted, in one embodiment, these supporting modules reside on an AHD and is part of the UPnP AHD service. However, they can be defined as a separate service and can reside in the AHD. The AHD may also reside on a remote access server (RAS). A remote access configuration component 902 has three supporting modules: access control 904, filtering service 906, and dynamic generator of device description 908. These modules function as a remote access control module which may operate in the RAS. However, regardless of where they execute, their function is to ensure that a remote device 910 can only access data that the device is authorized to access (or that the user of the remote device is authorized to access). The dashed line indicates that remote device 910 is operating outside the UPnP home network (i.e., it is operating remotely).

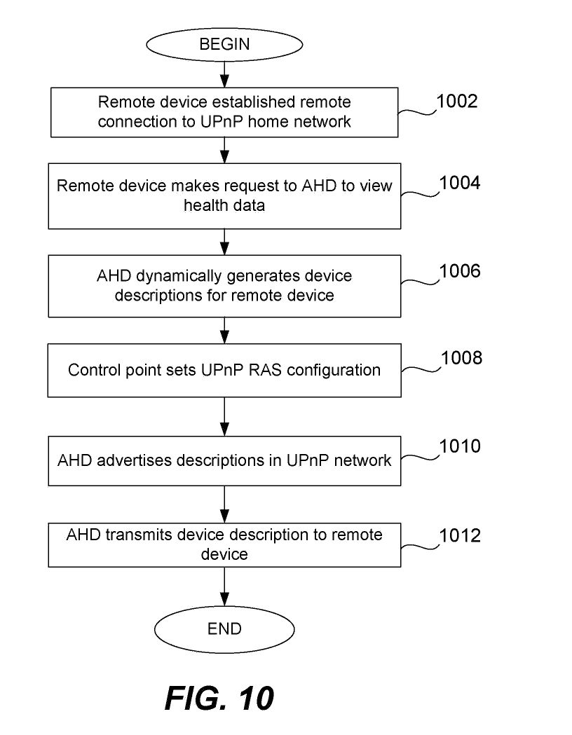

The remote device accesses the health data stored on an AHD at the home network through the remote access server (RAS), which is standard practice in UPnP. The configuration for this remote access is done by remote access which resides in the UPnP AHD service. The remote access support module is composed of access control 904, filtering service 906, and dynamic device description generator 908. These modules are described in greater detail in FIGS. 10A and 10B. Of particular interest is dynamic device description generation module 908 which the AHD can be used to dynamically generate a device description for the remote device that is attempting to access health measurement data in the AHD. Filtering service 906 performs filtering where only authorized interfaces and state variables with health record data are accessible to the remote device. For example, if the network has devices A, B, C, D, E and F, only devices A, C, and D may be shown to the remote device.

FIGS. 10A and 10B show a flow diagram of a remote device accessing health care data from a UPnP network in accordance with one embodiment. At step 1002 the remote device establishes remote access connection to the home network using UPnP connection. As described throughout above, the network may be a home network and the remote device may be a smart phone used by a member of the household in order to access health data. A control point on the UPnP AHD service sets an AHD data access and filter configuration.

At step 1004 the remote device makes a request to an AHD to remotely view health record data. This request can be transmitted using standard UPnP interactions. For example, a head of the household may want to view health data (e.g., blood glucose readings) of one of the children in the household while he is in the office using his smart phone.

At step 1006 the AHD dynamically generates device descriptions for the remote device based on the configuration set on the AHD. The device descriptions are created based on the configuration in the AHD, specifically, they are based on the access level for the device. In one embodiment, there are two types of device descriptions created by the AHD. One is for the local UPnP network and another is for the remote device, which is created dynamically, without knowing a priori, what type of device it is (i.e., the device description may be characterized as being created “on the fly” by the AHD). The local network description is blocked from being accessed by remote devices. This may be done by setting the configuration in the UPnP remote access server. The dynamically created device description for the remote devices is not blocked and is viewable by the remote devices. It functions as a second layer of security for access to the actual health data in the home UPnP network. As noted above, in UPnP, what a device is allowed to do is based on device description language, which can be static; that is, essentially the same description for any device or entity that sees it. In one embodiment a device description of the remote device is generated dynamically based on the configuration set on the UPnP AHD service by a UPnP health care-enabled control point. In various embodiments of the present invention, who or what is accessing the AHD and other factors can be used to dynamically generate the device description. The device description can have authentication information relating to the device and this can be used to control security to the health data.

At step 1008 the control point sets the UPnP RAS configuration on the RAS, thereby exposing the AHD with a specific service set. At step 1010 the AHD advertises the dynamically created device descriptions in the UPnP network. At step 1012 the AHD propagates the dynamically generated device descriptions to the remote device. The remote device uses the device description information to access health data from the AHD. The AHD only exposes data that the remote device is authorized to access. The health data transmitted between the AHD and the remote device may also be password protected for additional security during transmission and to ensure that an authorized user is viewing the data.

Various embodiments of the present invention include several features as described above. These include the IP LAN devices having implemented UPnP health services and advertising themselves to the UPnP network. These same features are also true for the AHDs, which also register themselves with the IP LAN devices for status updates. The IP LAN devices events out any status changes or updates to the AHD. The AHD may periodically invoke UPnP actions to gather health measurement data from the devices. There may be multiple AHDs in a network and an AHD can acts as an aggregator. Two AHDs can communicate with each other using UPnP interactions. Each AHD may have an embedded control point in order to invoke an action to retrieve status updates from another AHD. An AHD may have an eventing mechanism to event out any status updates and may have a communicator module that implements messaging and presence service to communicate with a remote (WAN) device. A DCP at an AHD may provide remote management of health data records (i.e., personal health records) and may have supporting modules, one of which is a dynamic generation of device description module.

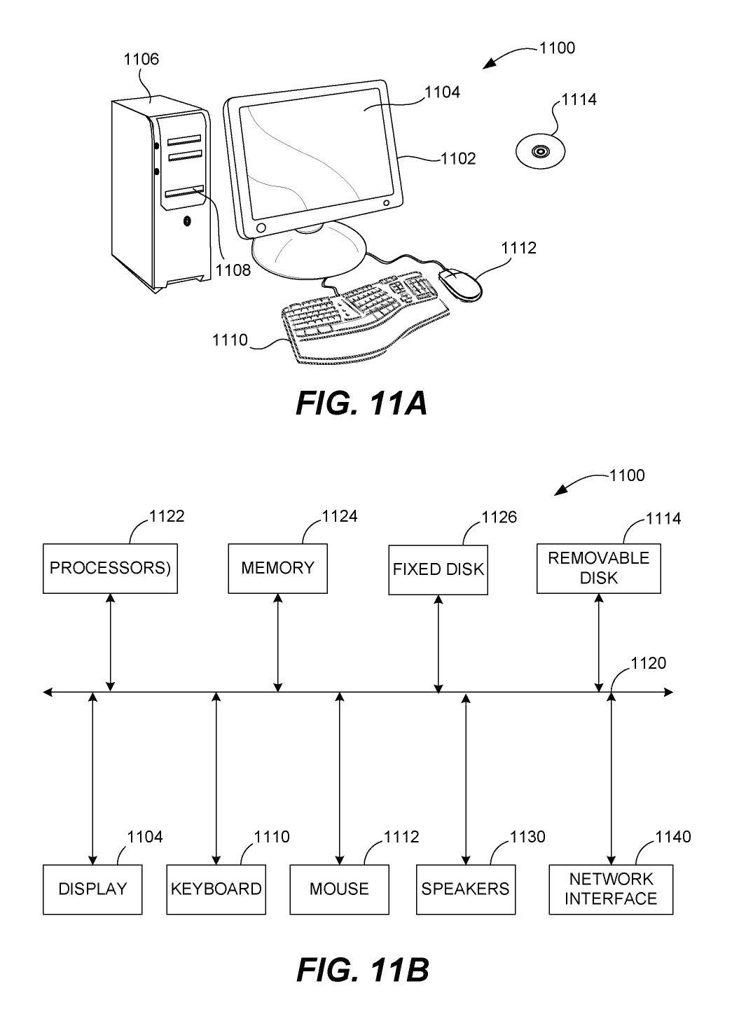

Various embodiments of the present invention describe devices, such as IP-LAN enabled health devices, AHDs, and remote (WAN) device. These devices may have various implementations, for example, as a smart phone or cell phone, a tablet computer, a netbook computer, an Ultra-Mobile PC (UMPC), a Mobile Internet Device (MID), a laptop or desktop computer, a server computer, or any other suitable device, such as a medical monitoring device. FIGS. 11A and 11B illustrate a generic computing device suitable for implementing specific embodiments of the present invention. FIG. 11A shows one possible physical implementation of a computing system. In one embodiment, system 1100 includes a display 1104. It may also have a keyboard 1110 that is shown on display 1104 or may be a physical component that is part of the device housing. It may have various ports such as HDMI or USB ports (not shown). Computer-readable media that may be coupled to device 1100 may include USB memory devices and various types of memory chips, sticks, and cards.

FIG. 11B is an example of a block diagram for computing system 1100. Attached to system bus 1120 is a variety of subsystems. Processor(s) 1122 are coupled to storage devices including memory 1124. Memory 1124 may include random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 1126 is also coupled bi-directionally to processor 1122; it provides additional data storage capacity and may also include any of the computer-readable media described below. Fixed disk 1126 may be used to store programs, data and the like and is typically a secondary storage medium that is slower than primary storage. It will be appreciated that the information retained within fixed disk 1126, may, in appropriate cases, be incorporated in standard fashion as virtual memory in memory 1124.

Processor 1122 is also coupled to a variety of input/output devices such as display 1104 and network interface 1140. In general, an input/output device may be any of: video displays, keyboards, microphones, touch-sensitive displays, tablets, styluses, voice or handwriting recognizers, biometrics readers, or other devices. Processor 1122 optionally may be coupled to another computer or telecommunications network using network interface 1140. With such a network interface, it is contemplated that the CPU might receive information from the network, or might output information to the network in the course of performing the above-described method steps. Furthermore, method embodiments of the present invention may execute solely upon processor 1122 or may execute over a network such as the Internet in conjunction with a remote processor that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are illustrative and not restrictive, and the invention is not to be limited to the details given herein, but may be modified within the scope and equivalents of the appended claims.

What is claimed is:

1. A method of managing health measurement data on a health management host device in a Universal Plug and Play (“UPnP”) network, the method comprising:
transmitting a health data query utilizing a UPnP request to a health sensor device, the health data query using a UPnP request protocol;
receiving health measurement data from the health sensor device via a UPnP interaction;
storing the health measurement data as a personal health record in a data storage component in the host device; and
managing access to the health measurement data using a UPnP health management service, wherein the host device and the health sensor device are discoverable in the UPnP network.

2. A method as recited in claim 1 further comprising:
announcing the presence of the host device to other devices in the UPnP network.

3. A method as recited in claim 1 further comprising:
creating the UPnP request using the UPnP health-management service on the host device.

4. A method as recited in claim 1 wherein the health sensor device is a biometric sensor operating as an Internet Protocol (IP)-enabled local area network (LAN) device.

5. A method as recited in claim 1 further comprising:
creating a personal health record, wherein said creating is performed by the UPnP health-management service.

6. A method as recited in claim 1 further comprising:
receiving an alert from the health sensor device, wherein the alert is communicated utilizing a UPnP event.

7. A method as recited in claim 1 further comprising:
subscribing with the health sensor device for receiving specific health data changes that exceed specific thresholds.

8. A method as recited in claim 7 further comprising utilizing a health-management host device control point to subscribe with the health sensor device.

9. A method as recited in claim 8 further comprising:
receiving status changes from the health sensor device over the UPnP network.

10. A method as recited in claim 1 further comprising:
executing a UPnP access control module for controlling access to the health measurement data, such that only authorized devices in the UPnP network can access the health measurement data.

11. A method as recited in claim 1 further comprising:
receiving instructions from an external control point software module to cause transmission of health measurement data to an external display for rendering.

12. A method as recited in claim 11 wherein the external control point software module is in a cell phone.

13. A method as recited in claim 1 wherein the health-monitoring host device functions as an aggregator device and communicates with a second health-monitoring host device, wherein the health-monitoring device stores health measurement data via UPnP interactions.

14. A method as recited in claim 1 wherein the wherein the health measurement data includes health measurement attribute data.

15. A method as recited in claim 1 further comprising:
allowing access the health measurement data based on a data access configuration programmed in the health-management host device.

16. A method as recited in claim 1 further comprising:
dynamically generating a device description for determining access to health measurement data in the host device.

17. A method as recited in claim 1 further comprising:
executing a filter on the host device to determine which devices in the UPnP are announced to the health sensor device.

18. A method as recited in claim 1 further comprising:
formulating the personal health record as having a measurement field and an attribute field.

19. A system for managing health sensor measurement data in a UPnP network, the system comprising:
a health-management application hosting device storing personal health sensor data and having a first UPnP service module for managing the personal health sensor data, an access control component for controlling access to the health sensor data, and a health data synchronization module; and
a health sensor device executing biometric readings and storing said biometric readings of a user and having an IP-enabled interface, second UPnP service module, a health-sensor device control point module, and biometric functionality, wherein the biometric readings are stored as the personal health sensor data on the health-management application hosting device and are transmitted using a UPnP interaction, and wherein the health-sensor device control point module communicates with the first UPnP service module on the health-monitoring hosting device.

20. A system as recited in claim 19 further comprising:
a remote access device communicating with the health-monitoring hosting device for accessing health sensor measurement data and having a third UPnP service module for remotely communicating with the UPnP network.

21. A system as recited in claim 19 wherein the health-management application hosting device further comprises:
a remote health sensor data access module; and
a security configuration module.

22. A system as recited in claim 21 wherein the security configuration module further comprises:
a remote access control module;
a filtering service module; and
a dynamic device description generation module.

23. A system as recited in claim 19 wherein the personal health sensor data is stored as a personal health record corresponding to one user and containing health sensor measurement data from one or more health sensor devices in the UPnP network.

24. A system as recited in claim 19 further comprising:
one or more non-IP enabled devices executing biometric readings and storing said biometric readings and transmitting the readings to the health sensor device using radio frequency.

25. A system as recited in claim 19 wherein the first UPnP service module is discoverable by the health sensor device and the second UPnP service module is discoverable by the health-monitoring application hosting device.

26. A system as recited in claim 20 further comprising:
a health-management application aggregator module for enabling communication among two or more health-monitoring application hosting devices and for facilitating secure access from the remote access device.

27. A system as recited in claim 23 wherein a personal health record contains health measurement data for a specific health sensor device and attribute data relating to the health measurement data.

28. A health data management apparatus comprising:
a processor;
a network interface;
a storage component for storing a health data synchronization module executed by the processor, wherein the module manages health sensor data stored in the storage component and formulates a personal health record containing health sensor data for one user; and
an access control module for controlling access to the health sensor data from a remote device, and a dynamic device description generation module for generating a device description used to determine access rights of a remote device.

29. A health data management apparatus as recited in claim 28 further comprising a filtering module for determining which health sensor devices in a UPnP network are displayed to the remote device.

30. A health data management apparatus as recited in claim 28 wherein the dynamic device description generation module dynamically generates a device description of the remote device.

31. A health data management apparatus as recited in claim 28 wherein the access control module controls access by the remote device to a UPnP network.

32. A method of a remotely accessing health measurement data in a UPnP network, the method comprising:
receiving a request from a remote device to access health data on a health data server;
verifying security access of the remote device to ensure that the remote device can securely access data on the health data server;
generating a device description for the remote device using a device description generator; and
determining health data access authorization of the remote device by examining health data access information and the device description.

33. A method as recited in claim 32 further comprising:
transmitting a list of devices in the UPnP network to the remote device.

34. A method as recited in claim 32 wherein the device description is generated based on an access level of the remote device.

35. A method as recited in claim 34 wherein the device description stores authentication data and is based on access control settings.

36. A method as recited in claim 32 further comprising:
advertising the device description to devices in the UPnP network.
